(19) United States
(12) Patent Application Publication
(10) Pub. No.: US 2020/0221837 A1
(43) Pub. Date: Jul. 16, 2020

(54) Self-balancing electric motorized luggage

(71) Applicant: Martin Pak-Lun Fu, Sheffield (GB)

(72) Inventor: Martin Pak-Lun Fu, Sheffield (GB)

(21) Appl. No.: 16/249,365

(22) Filed: Jan. 16, 2019

(51) Int. Cl. A45C 5/14; A45C 5/03; A45C 13/26; A45C 15/06; A45C 13/04; G05D 1/02

(52) U.S. Cl. CPC A45C 5/14; A45C 5/03; A45C 13/262; A45C 15/06; B60B 19/003; G05D 1/021; G05D 1/0255; A45C 2013/267; A45C 13/04

(57) ABSTRACT

The present invention produces a self-balancing electric motorized luggage capable of relieving the user from the burden of luggage weight handling, in particular, continue usability on inclines, uneven surfaces and crowded spaces.

With utilizing of the gyroscope self-balancing system and two motorized wheels, the self-balancing electric motorized luggage is capable of auto-adjusting its centre of gravity point to remain self-balanced in an upright position during operation. When in motion, the luggage will synchronize with the user's speed and running surface by automatically reducing its speed down a decline or increasing power when up an incline. In addition, this luggage is designed with a U-shaped width bottom, and uses narrow depth of the main container as lead to a direction. This configuration allows the user to have close control of the luggage operating beside them. With motor/user synchronisation, nearly all physical stresses on the arm, shoulders and back are removed.

### FIELD OF THE INVENTION

The present invention relates to a handheld/wheeled travel luggage type, and electric motorized Wheel carrier. More particularly, the invention relates to a self-balancing electric motorized luggage that is capable of in-motion speed optimization, for the purpose of removing all pressure or force of the carrying weight from the user during motor operation.

This includes the motor operating on inclines, uneven surfaces and crowded spaces. It can also be reposition to a non-motorized wheeled luggage configuration during manual operation.

### BACKGROUND OF THE INVENTION

Wheeled travel luggage types are widely documented and sold, accounting for around 70% of the market share. This invention greatly assists the user with weight handling by dragging or pushing the luggage on its wheels rather than lifting. Conventional wheeled luggage consists of a main container with a retractable handle mounted on a two or four wheeled assembly. Two wheeled luggage can be dragged on its wheels behind the user when tilted towards its back. However, the issue with dragging is that when the luggage is inclined towards the user, the weight is also shifted and creates pressure on the user's dragging arm, shoulder and back. This pressure becomes more apparent on angled surfaces, with the user exerting more physical force as compensation for control over the speed and movement of the luggage. With that in mind, the four-wheeled luggage was introduced with the aim to further absorb the luggage's weight when dragged or pushed around on four wheels. While this proved to be a popular choice, however, both inventions do not resolve the problem of handling the luggage's weight during motion. When being dragged or pushed, the luggage's weight still poses as a problem which leaves the user being physically exhausted over the distance of the journey.

Furthermore, a number of motorized luggage inventions became available on the market in an attempt to resolve this problem by substituting man power with technology. Examples such as ride-on scooter type luggage, motorized remote control/object follow luggage or motorized start/stop luggage or intelligent smart luggage. Each invention, although, addresses the weight handling problem, they do so in an obvious manner that sacrifices practicality and usability as a whole product. Resulting in ride-on type luggage being banned by airports due to public safety concerns and other smart luggage types facing bans on planes due to concerns of overheat of non-removable batteries. Moreover, these inventions are designed to be used in wide open spaces, with the user reverting back to man power when the main motorized function is un-useable in crowded areas. Some other issues include, the luggage moving down a slope on its own as the motor is not self-balancing, the net weight being nearly half the typical baggage weight limit, or central storage compartment size reduced for motorized parts.

More importantly for a wheeled luggage, being motorized or not, is defined by the wheels selection. The typical wheel selection size found on these luggage types is between 50-80 mm in diameter, they are either in-line skate style wheels or spinner wheels for two wheeled and four wheeled configurations respectively. The problem with this range, aside from noise, is that they are only suitable for running on flat smooth surfaces (i.e. tiles, carpet, laminate, etc.) and creates drag resistance on rough uneven surfaces such as typical roads, pathways (i.e. tarmac, concrete, gravel, etc.). More so, for non-motorized luggage, as the combination of net weight, incline gradient and uneven surfaces amplifies the weight handling problem for the user.

Ultimately, all present invention, from design, selection of wheels and the use of technology have yet to combine effectively to produce a luggage that fully transfer the handling weight from the user.

### SUMMARY OF THE INVENTION AND ADVANTAGES

The present invention produce a Self-balancing electric motorized luggage capable of relieving the user from the burden of luggage weight handling, in particular, continue usability on inclines, uneven surfaces and crowded spaces.

With utilizing of the gyroscope self-balancing system and two motorized wheels, the self-balancing electric motorized luggage is capable of auto-adjusting its centre of gravity point In real time to remain self-balanced in an upright position during motor operation. Over flat or angled surfaces the luggage will remain upright, and only a gentle inclination of the handle is needed to guide the luggage to a direction. When in motion, the luggage will synchronize with the user's speed and terrain surface by automatically reducing its speed down a decline or increasing power when up an incline. In addition, this luggage is designed with a ‘U’ shaped bottom, and uses the narrow depth of the main container on either side to lead the direction forwards or backwards. This configuration allows the user to have close control of the luggage operating side by side of them. Conventional dragging or pushing is eliminated, and when combined with motor/user synchronisation, nearly all physical stresses on the arm, shoulders and back are removed. Also, this configuration consumes less operating space with the narrowest surface of the luggage leading the direction, thus aids manoeuvring in tight spaces, making it suitable for crowded areas.

Regarding wheels selection, the luggage will use two large wheels with inflatable pneumatic tires. Pneumatic tires have great ability to absorb bumpy, uneven surfaces, along with reducing wobble, and noise. Paired with an increase in size, this wheel selection benefits from an increased range of useable terrains, more control and drag resistance reductions over conventional selections.

Addressing IATA regulations, the Rechargeable battery pack is removable for the convenience of check-in. Moreover, in scenarios where the battery has no power or manual operation is demanded, the present invention can be rotated and operate on four wheels at the side of the luggage.

A combination of unconventional designs, motor/user synchronisation along with practical wheel selection, produced an invention capable of substituting man power with motor power in most types of environment.

### BRIEF DESCRIPTION OF THE DRAWINGS

A clear understanding of the key features for the above summarized invention may be had by reference to the appended drawings, which illustrate the system and method of the invention. However, such drawings depict preferred embodiments of the invention and, therefore, not to be considered as limiting the scope with regards to other embodiments which the invention can contemplate.

FIG. 1—The drawing illustrates an intersection of a preferred embodiments of the present invention comprising of:

1 is an illustration of a Main container with a pivotal opening cover and a ‘U’ Shaped bottom.

2 is an illustration of a first extendable handle.

3 is an illustration of a gyroscope sensor.

4 is an illustration of a Rechargeable battery pack with removable snap-in function.

5 is an illustration of a metal housing frame.

6 is an illustration of a Set of motor wheels comprising of two 200 mm motorized wheels with inflatable pneumatic tires, one on each side and in parallel to the width of the main container.

7, 8 is an illustration of a main controller board compromising the following:

7 a micro controller board.

8 a motors controller board.

9 is an illustration of a Set of manual wheels comprising of two roller ball bearing wheels and two Omni-direction wheels for operating in the Manual mode.

Note—the other preferred embodiments is not illustrated in this drawing, embodiments such as a Set of four buttons, Sets of electrical wiring, a Second extendable handle for the Manual mode.

FIG. 2—A perspective view of the preferred embodiments of the present invention displays the ‘U’ Shaped bottom in the Self-Balancing mode. It also illustrates the correct way of operation with the user side by side of Self-balancing electric motorized luggage and with the narrow depth of the main container of either FIG. 5 A Side or B Side leading to a direction. A gentle inclination of the handle will direct the luggage forwards or backwards.

FIG. 3—A drawing to illustrate the preferred embodiment of the present invention with the ‘U’ shaped design on an incline.

1 is an illustration of the main container with ‘U’ shaped bottom.

2 is an illustration of the 200 mm motorized wheels with inflatable pneumatic tires in parallel alignment with the width of the main container.

3 is an illustration of the maximum incline range of 30 degrees for the ‘U’ shaped design.

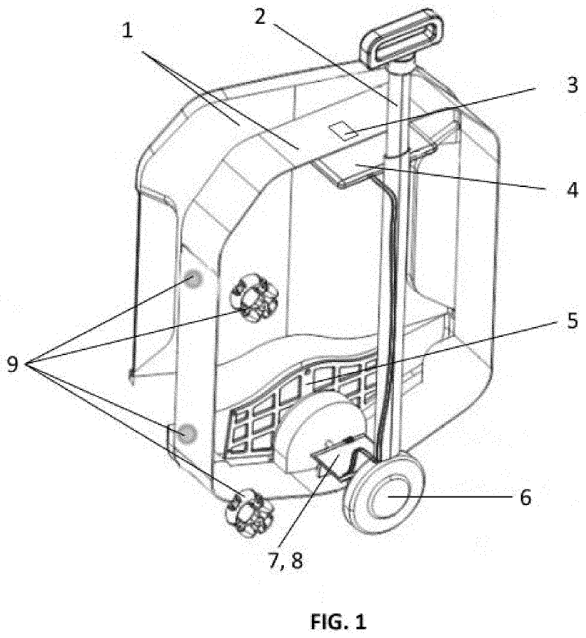

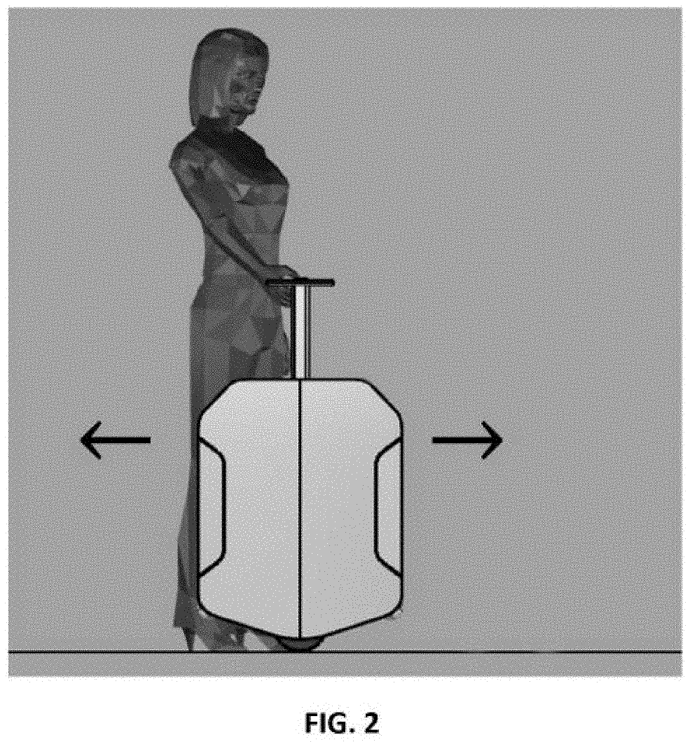

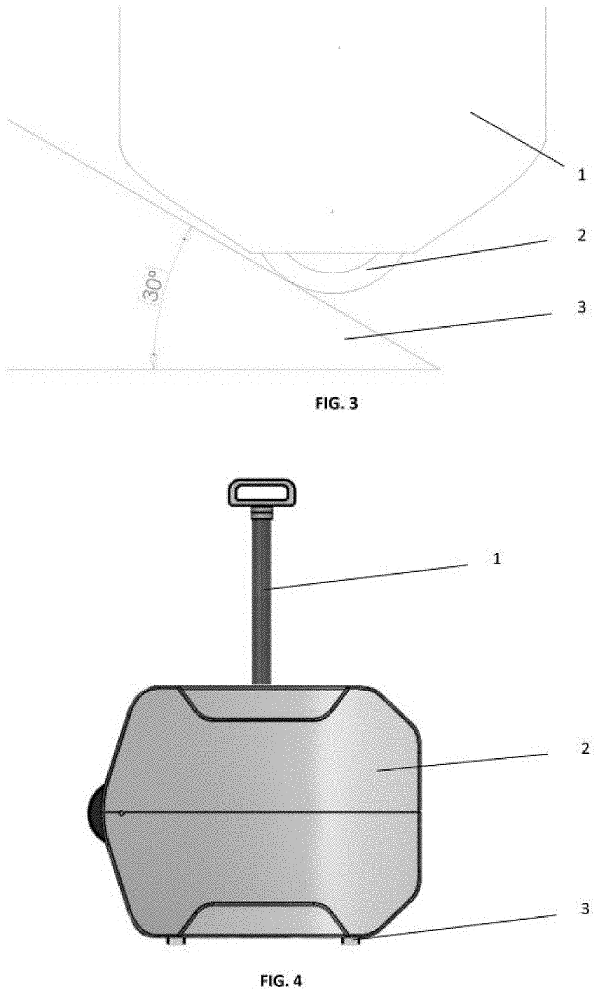

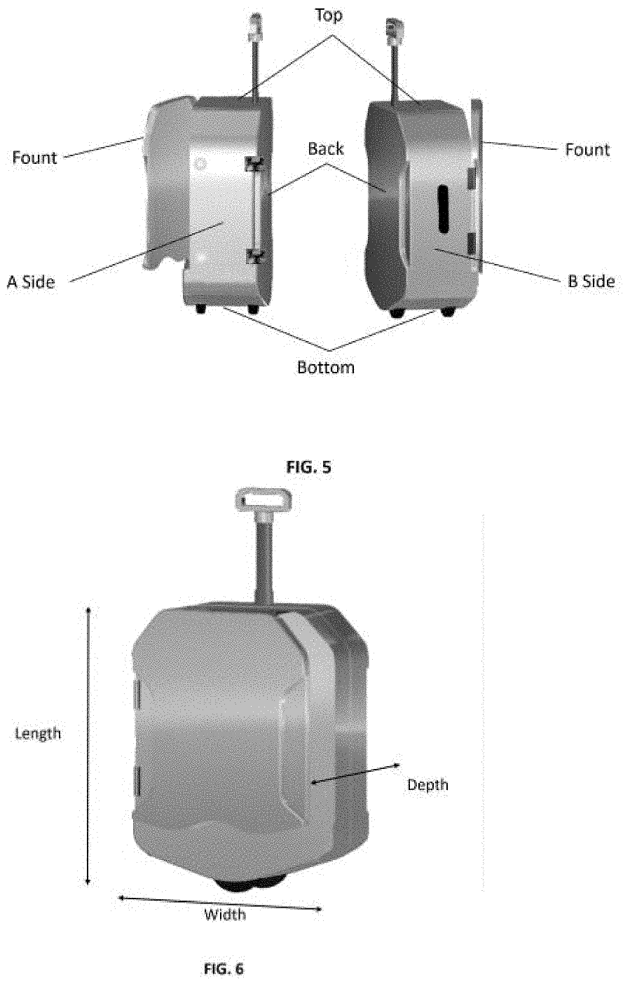

FIG. 4—A drawing to illustrate the present invention rotated to the Manual mode, operation on FIG. 1.9 & FIG. 5 a Set of manual wheels comprising of four wheels mounted on A Side.

1 is an illustration of the Second extendable handle.

2 is an illustration of the main container.

3 is an illustration of the Set of manual wheels comprising of two rolling ball bearing wheels and two Omni-direction wheels.

FIG. 5—A drawing of the perspective view showing the preferred embodiments in an assembled state of the present invention. It depicts A Side and B Side, along with FIG. 6 showing the depth, highlights FIG. 2 the method of using the narrowest part of the main container as lead to a direction, with the Set of motor wheels at the bottom in parallel alignment with the width of the main container.

Note—the preferred embodiments in this drawing does not illustrate the second extendable handle for the Manual mode.

FIG. 6—is an illustration a preferred embodiment of the present invention in Self-Balancing mode and highlights the dimensions of the main container.

Note—the preferred embodiments in this drawing does not illustrate the Set of manual wheels.

### DETAILED DESCRIPTION OF THE INVENTION

The self-balancing electric motorized luggage pertains to a portable Self-balancing motorized travel luggage which can operate in either the Self-balancing motorized mode or Manual rolling mode.

The self-balancing electric motorized luggage means maintaining an upright position by its centre of gravity, fully capable of managing its net weight and in real time maintains the balancing between its motor wheels during operation. It uses a variety of electrical processors comprising of FIG. 1 reference line 3 a Gyro sensor mounted thereon to maintain the balancing between FIG. 1 reference line 6 the two motor wheels of 200 m motorized wheels with inflatable pneumatic tires, the variety of electrical processors are operated by FIG. 1 reference line 7, 8 a main controller board housing the Micro and Motor controller, powered by the FIG. 1 reference line 4 the Rechargeable battery pack and controlled by four switch buttons to form a Gyroscope self-balancing system and thereby maintaining the balancing.

FIG. 1 reference line 4 the Rechargeable pack comprises of a pack of 24 Volt rechargeable batteries with a step-down generator is electronically connected to FIG. 1 reference line 7, 8 the main controller board, and supply a predetermined level of energy to the Set of motor wheels corresponding to selection of the operator. The Rechargeable battery pack is snap-fit into the inner shell of the main container to allow for easy installation and removal in accordance to airport security. Note: The snap-fit housing is not illustrated in the drawings provided.

The self-balancing electric motorized luggage moves in accordance with the inclinations of a gentle push or pull of the user. The inclinations of the user are sensed in real time through the Gyro sensor, and based upon the sensed results are calculated through the main controller board to activate the Set of motor wheels, while preventing the self-balancing electric motorized luggage from over turning. That is, the motor wheels are activated in real time in accordance with the values of the inclinations of the user movements, so the luggage can be performed in the state where the self-balancing motorized luggage is always upright. With this technique the luggage can always be synchronized with the user's walking speed, while carrying the weight up or down an incline without losing balance. FIG. 3 the ‘U’ shaped design makes it possible for the luggage to go up or down an incline in an upright position.

The self-balancing motorized travel luggage can operate in two operation modes, a Self-balancing mode and a Manual mode. In FIG. 2 the Self-balancing mode, FIG. 1 reference line 2 the first extendable handle is used to transfer the inclinations between the user and the Set of two motor wheels. A Set of four buttons, an On/Off switch button, a Pause/Resume function switch button and two Arrowed switch buttons are used as control during the Self-balancing mode. All buttons are used to execute a respective command and connected electronically to the gyroscope self-balancing system. Note: All switch button embodiments are not illustrated in the drawings provided, may change in number, or located separately on different parts of the luggage. The On/Off switch button is electronically connected to the Rechargeable battery pack for supplying or cutting off electrical power when toggled. The Pause/Resume button is connected to FIG. 1 reference line 7, 8 the main controller board to stop or resume all motor functions, with the gyroscope self-balancing system still receiving power and on standby. When Pause is activated, the current centre of gravity point value will be recorded in memory, and then the motor wheels become free moving. When Resume is activated, the motor function will resume when the previous centre of gravity point value is found by the gyroscope sensor. The Two arrowed switch buttons are for manually adjusting the luggage's centre gravity to forward or backwards to an appropriate upright position.

That is, FIG. 1 reference line 5 the metal housing along with the main container will adjust its axis forward or backwards irrespective of the motor wheels movement and, in accordance to the user control. This is for scenarios such as shifting contents inside the luggage or to exert more control over the luggage on an incline.

During operation in the Self-balancing mode, a method of using FIG. 2, FIG. 5, FIG. 6 the depth of the main container of A Side or B Side to lead the direction forward or backwards, this means using the narrowest or smallest front or back facing surface area as lead. This is an ergonomic and space saving design aimed for the luggage to operate on either the left or right hand side of the user. This allows the user full control over luggage manipulation beside of them, enhancing safety to oneself and the public. Nearly all physical stresses on the arm, shoulders and back are removed due to the elimination of dragging or pushing the luggage. Note: User should only operate the luggage on either side and not in front of or behind them.

In FIG. 2 the Manual mode, the present invention can be re-position to operate on FIG. 1 reference line 9 & FIG. 4 reference line 3 a Set of manual wheels comprising of two roller ball bearing wheels and, two Omni-direction wheels that are attached on either FIG. 5 A Side or B Side of the main container, for moving along the ground as illustrated in FIG. 4. FIG. 4 reference line 1 the second extendable handle is used to guide the luggage to any direction on four wheels or can be dragged behind the user when inclined on two wheels. This manual mode allows the user to operate the luggage during power-out situation or the Rechargeable battery pack removal for checking-in luggage.

1. A Self-balancing electric motorized luggage comprising:
a. a luggage type main container with a ‘U’ shaped bottom for holding various items therein;
b. a Set of motor wheels comprises of two 200 mm motor wheels with pneumatic tires, individually rotatable, are mechanically attached in parallel alignment to the width of the metal housing frame that is fixed to inner bottom widthwise of the said main container, for allowing the said main container to move along the ground with the Set of motor wheels pointing to A Side, B Side of the said main container;
c. a gyroscope self-balancing system comprising of a gyroscope sensor, main controller board with micro-controller, motor-controller, the said Set of motor wheels, all interconnected electronically, fixated on the said main container and the metal housing frame;
d. the Rechargeable battery pack supplying electric current to said gyroscope self-balancing system, attached with removable snap-in function to the said main container;
e. a first extendable handle is fixed to the said main container for guiding said main container to desired direction with the narrow depth of either A Side or B Side to lead a direction during operation in the Self-Balancing mode;
f. a Set of four switch buttons electrically connected with said gyroscope self-balancing system, On/Off switch button will turn said gyroscope self-Balancing system on or off, Pause/Resume to stop or resume motor functions, two Arrowed switch buttons to adjust centre of gravity point of the said main container forward or backwards;
g. a Set of manual wheels comprising of two roller ball bearing and two Omni-direction, mounted on the narrow depth of the main container that is on either A Side or B Side of said main container, for allowing the said main container to move along the ground in the Manual mode;
h. a second extendable handle is fixed on the back of the said contain for guiding said main container during operation in the Manual mode, for allowing the said main container to move along the ground with the said Set of manual wheels.

2. A Self-balancing electric motorized luggage as recited in claim 1, wherein said Set of motor wheels with sizes not limited to 200 mm motor wheels with non-pneumatic tires/wheels.

3. A Self-balancing electric motorized luggage as recited in claim 1, wherein said Set of motor wheels with sizes not limited to 200 mm motor wheels with pneumatic tires.

4. A Self-balancing electric motorized luggage as recited in claim 1, wherein said Set of manual wheels comprise of four Omni-wheels.

5. A Self-balancing electric motorized luggage as recited in claim 1, wherein said Set of manual wheels comprise of four roller wheels.

6. A Self-balancing electric motorized luggage as recited in claim 1, wherein said main container comprises of LED lighting.

7. A Self-balancing electric motorized luggage as recited in claim 1, wherein comprises of aerodynamic embodiments as lead to a direction with the narrowest and/or smallest surface of the luggage, such as and not limited to said main container shape change, or additional pointer type component.

8. A Self-balancing electric motorized luggage as recited in claim 1, wherein comprises of Bluetooth transmitter/receiver to enable Bluetooth connectivity and functions such as, and not limited to, syncing with a mobile phone to receive commands via a mobile phone application to control and not limited to send commands to the main controller board and gyroscope self-balancing system.

9. A Self-balancing electric motorized luggage as recited in claim 1, wherein comprises of Wifi transmitter/receiver to enable Wifi connectivity and functions such as, and not limited to, syncing with a mobile phone to receive commands via a mobile phone application to control and not limited to send commands to the main controller board and gyroscope self-balancing system.

10. A Self-balancing electric motorized luggage as recited in claim 1, wherein comprises of GPS type transmitter/receiver to enable GPS connectivity and functions such as real-time luggage location.

11. A Self-balancing electric motorized luggage as recited in claim 1, wherein comprises of microphone and speaker with varies electronics for voice commands and sound feedback, such as and not limited to send commands to the main controller board, switch button feedback, user guiding feedback.

12. A Self-balancing electric motorized luggage as recited in claim 1, wherein comprises of vibration type device for uses such as, and not limited to switch button feedback, user guiding feedback.

13. A Self-balancing electric motorized luggage as recited in claim 1, wherein said main container with one extendable handle, where said one extendable handle is joined to the said main container on a pivot, so rotatable and snap in to use as guide for either the Self balancing mode or the Manual mode.

14. A Self-balancing electric motorized luggage as recited in claim 1, wherein comprises of infrared sensors for uses such as, and not limited to stop or resume motor functions when certain conditions are met.

15. A Self-balancing electric motorized luggage as recited in claim 1, wherein comprises of Digital displays for information display, such as and not limited to LED digital displays.

16. A Self-balancing electric motorized luggage as recited in claim 1, wherein said gyroscope self-balancing system comprises a combination of encoders, ultrasonic sensors, for fully autonomous self-balancing and remote-control functions.

17. A Self-balancing electric motorized luggage as recited in claim 1.16, wherein comprises of microphone and speaker with varies and not limited to electronics, mobile phone application for voice commands and sound feedback, such as and not limited to execute control commands, switch button feedback, sensor feedback, user guiding feedback.

18. A Self-balancing electric motorized luggage as recited in claim 1.16, wherein comprises of vibration type device for uses such as and not limited to switch button feedback, sensor feedback, user guiding feedback.

19. A method of operating of claim 1 the Self-balancing electric motorized luggage in Self-balancing mode comprises of the following steps:
a. with the Self-balancing electric motorized luggage powered off, stand the luggage upright with the ‘U’ Shaped bottom of main container resting on the Set of motor wheels;
b. with use of the first extendable handle stables as guide, stabilize the Self-balancing electric motorized luggage on its centre of gravity, then press the on/off switch button to power on the gyroscope self-balancing system;
c. keep a hold of the first extendable handle at all times during operation, press the appropriate arrow switch button to adjust the centre of gravity forward or backwards or the Pause/Resume switch button to stop or resume motor function if require; Note: previous centre of gravity point will be used when resume after executing the stop motor function;
d. re-position oneself so the Self-balancing electric motorized luggage is side by side, with the narrow depth (narrowest/smallest front facing surface of the luggage) of the main container of A Side, B Side facing forward, backward, and the width of the main container in parallel alignment to the length of the user's foot;
e. guide the Self-balancing electric motorized luggage by applying gentle inclination forward or backward to the desired direction;
f. the Self-balancing electric motorized luggage should be guided side by side of the user during operation, even on inclines or over rough surfaces. If require, the pause/resume switch button is used to stop motor function, for lifting the luggage off the ground, etc;
g. to power off, stable the Self-balancing electric motorized luggage to a stop, then press the on/off switch button.
